(19) United States
(12) Patent Application Publication
(10) Pub. No.: US 2009/0244111 A1
(43) Pub. Date: Oct. 1, 2009

(54) DISPLAY DEVICE AND DRIVING APPARATUS AND METHOD THEREOF

(76) Inventors: Young-Chol Yang, Gyeonggi-do (KR); Ho-Yong Jeong, Gyeonggi-do (KR); Mun-Pyo Hong, Gyeonggi-do (KR); Keun-Kyu Song, Gyeonggi-do (KR)

Correspondence Address: F. CHAU & ASSOCIATES, LLC, 130 WOODBURY ROAD, WOODBURY, NY, 11797, US

(21) Appl. No.: 12/480,960

(22) Filed: Jun. 9, 2009

Related U.S. Application Data
(62) Division of application No. 11/137,868, filed on May 25, 2005.

(30) Foreign Application Priority Data
Jun. 25, 2004 (KR) 10-2004-0048071

(51) Int. Cl. G09G 5/10

(52) U.S. Cl. 345/690

(57) ABSTRACT

A data processor receives sets of input image data having respective input grays and outputs sets of output image data having respective output grays. Each set of output image data corresponds to one of the plurality of sets of input image data and have more image data than each set of the input image data. A data driver supplies the pixels with data voltages corresponding to the output image data supplied from the data processor. A set of output grays corresponding to a set of input grays are selected from sets of grays, each set of grays giving an average front transmittance substantially equal to an average front transmittance of the set of input grays. The sets of output grays generate the closest average lateral gamma curve generated by the sets of grays relative to an average front gamma curve generated by the input grays.

### CROSS-REFERENCE TO RELATED APPLICATION

This application is a Divisional Application of U.S. patent application Ser. No. 11/137,868, filed on May 25, 2005, which claims priority to Korean Patent Application No. 10-2004-0048071, filed on Jun. 25, 2004, the disclosures of which are incorporated by reference herein in their entireties.

### BACKGROUND OF THE INVENTION

(a) Field of the Invention

The present invention relates to a display device and a driving apparatus 5 and method thereof.

(b) Description of Related Art

A display device such as a liquid crystal display (LCD) and an organic light emitting display (OLED) generally includes a plurality of pixels arranged in a matrix and including switching elements and a plurality of signal lines such as gate lines and data lines for transmitting signals to the switching elements. The switching elements of the pixels selectively transmit data signals from the data lines to the pixels in response to gate signals from the gate lines for displaying images. The pixels of the LCD adjust transmittance of incident light depending on the data signals, while those of the OLED adjust luminance of light emission depending on the data signals.

In the meantime, an LCD includes a pair of panels provided with field generating electrodes and a liquid crystal (LC) layer having dielectric anisotropy, which is disposed between the two panels. The field generating electrodes generally include a plurality of pixel electrodes connected to switching elements such as thin film transistors (TFTs) to be supplied with data voltages and a common electrode covering an entire surface of a panel and supplied with a common voltage. A pair of field generating electrodes that generate the electric field in cooperation with each other and a liquid crystal disposed therebetween form so called a liquid crystal capacitor.

The LCD applies the voltages to the field generating electrodes to generate an electric field across the liquid crystal layer, and the strength of the electric field can be controlled by adjusting the voltage across the liquid crystal capacitor. Since the electric field determines the orientations of liquid crystal molecules and the molecular orientations determine the transmittance of light passing through the liquid crystal layer, the light transmittance is adjusted by controlling the applied voltages, thereby obtaining desired images.

An LCD, in particular, one employing vertical electric field exhibits different light transmittance between a front view and a side view due to the

different optical phase retardation of liquid crystal between the front view and the side view. Therefore, the visibility in the front view and in the side view is differentiated.

For example, the light transmittance for low grays in an LCD increases when moving from the front of the panel toward the side, while that for high grays decreases when moving from the front of the panel toward the side. Accordingly, the difference in the light transmittance between the grays is decreased to deteriorate visibility.

For reducing the deterioration of the visibility in the side view, a pixel divided into two subpixels having different voltages is suggested. For differentiating the voltage of the subpixels, LC capacitors of the two subpixels are connected by a coupling capacitor or one of the subpixels is periodically supplied with a fixed voltage.

However, the ratio of the voltages charged in the two LC capacitors is determined by capacitances of various capacitors and thus appropriate voltages for a given gray may not be charged in the LC capacitors. Accordingly, the improvement provided by the above-described method has a limitation.

### SUMMARY OF THE INVENTION

An apparatus of driving a display device including a plurality of pixels is provided, which includes: a data processor that receives a plurality of sets of input image data having respective input grays and outputs a plurality of sets of output image data having respective output grays, each set of output image data corresponding to one of the plurality of sets of input image data and having more image data than each set of the input image data; and a data driver that supplies the pixels with data voltages corresponding to the output image data supplied from the data processor, wherein a set of output grays corresponding to a set of input grays are selected from at least one set of grays, each set of grays giving an average front transmittance substantially equal to an average front transmittance of the set of input grays, and the sets of output grays generate the closest one of the average lateral gamma curves generated by the sets of grays relative to an average front gamma curve generated by the sets of input grays.

Each pixel may include a plurality of subpixels and the data processor assigns the output image data in each set of output images to the respective subpixels.

The subpixels may be arranged in a row direction or in a column direction.

A set of output grays for an input gray may include a higher output gray higher than the input gray and a lower output gray lower than the input gray and each set of output image data may include a higher output image data having the higher output gray and a lower output image data having the lower output gray.

The apparatus may further include a gray voltage generator generating a plurality of gray voltages, wherein the data voltages are selected from the gray voltages.

A frame frequency of the output image data may be twice a frame frequency of the input image data.

The data voltages may include lower data voltages corresponding to the lower output image data and higher data voltages corresponding to the higher output image data.

Either the lower data voltages or the higher data voltages may be successively applied for at least two frames and the polarity of the data voltages may be inverted every frame.

The lower data voltages and the higher data voltages may be alternately applied and the polarity of the data voltages may be inverted every frame.

The apparatus may further include a look-up table storing the corresponding values between the input grays and the output grays.

The data processor may calculate a time-averaged transmittance by time-averaging the transmittance of the input image data based on a ratio of a frame frequency of the input image data and a frame frequency of the output image data, may find modified grays corresponding to the time-averaged transmittance, and may obtain the output grays based on the modified grays.

The apparatus may further include a look-up table storing the corresponding values between the modified grays and the output grays.

The time-averaged transmittance (Sₖ′) for a k-th interval (k=1, 2, . . . ) may be given by:

$${S}_{k}^{′} = \frac{1}{x} \times \{ [ k - ( k - 1 ) x ] {S}_{k} + ( kx - k ) {S}_{k + 1} \} ,$$

where the k-th interval indicates the k-th interval among intervals from a point where beginning of a frame of the input image data coincides with beginning of a frame of the output image data to a next point where beginning of a frame of the input image data coincides with beginning of a frame of the output image data, the length of the k-th interval is equal to two frames of the output image data, and x=2p/q (where the ratio of the frame frequency of the input image data and the frame frequency of the output image data is equal to p:q).

A method of driving a display device including a look-up table is provided, which includes: receiving input image data having input grays; calculating a modified gray by time-averaging the transmittance of the input grays; reading out a plurality of output grays corresponding to the modified gray from the look-up table; and outputting a plurality of output image data having the output grays.

The calculation of the modified gray may include: gamma converting the input grays to obtain the transmittance corresponding to the input grays; time-averaging the transmittance to obtain a time-averaged transmittance; and inverse-gamma converting the time-averaged transmittance to obtain the modified gray.

The time-averaged transmittance (Sₖ′) for a k-th interval (k=1, 2, . . . ) is given by:

$${S}_{k}^{′} = \frac{1}{x} \times \{ [ k - ( k - 1 ) x ] {S}_{k} + ( kx - k ) {S}_{k + 1} \} ,$$

where the k-th interval indicates the k-th interval among intervals from a point where beginning of a frame of the input image data coincides with beginning of a frame of the output image data to a next point where beginning of a frame of the input image data coincides with beginning of a frame of the output image data, the length of the k-th interval is equal to two frames of the output image data, and x=2p/q (where the ratio of the frame frequency of the input image data and the frame frequency of the output image data is equal to p:q).

A display device is provided, which includes: a plurality of pixels including switching elements; a plurality of gate lines transmitting gate signals to the switching elements; a plurality of data lines connected to the switching elements; a signal controller that selects a plurality of output grays based on input grays of input image data and outputs a plurality of output image data having the output grays; and a data driver that applies data voltages corresponding to the output image data supplied from the signal controller to the switching elements through the data lines, wherein the output grays corresponding to an input gray are selected from at least one set of grays giving an average front transmittance substantially equal to a front transmittance of the input gray and the output grays generate the closest one of the average lateral gamma curves generated by at least one set of grays relative to a front gamma curve generated by the input grays.

Each pixel may include a plurality of subpixels, each subpixel may include the switching element, and the subpixels of a pixel may be supplied with data voltages corresponding to an input gray for the pixel.

The signal controller may include a look-up table storing the correspondence between the input grays and the output grays.

The signal controller may calculate a time-averaged transmittance by time-averaging the transmittance of the input image data based on a ratio of a frame frequency of the input image data and a frame frequency of the output image data, may find modified grays corresponding to the time-averaged transmittance, and may obtain the output grays based on the modified grays.

The signal controller may include a look-up table storing the correspondence between the modified grays and the output grays.

The time-averaged transmittance (Sₖ′) for a k-th interval (k=1, 2, . . . ) may be given by:

$${S}_{k}^{′} = \frac{1}{x} \times \{ [ k - ( k - 1 ) x ] {S}_{k} + ( kx - k ) {S}_{k + 1} \} ,$$

where the k-th interval indicates the k-th interval among intervals from a point where beginning of a frame of the input image data coincides with beginning of a frame of the output image data to a next point where beginning of a frame of the input image data coincides with beginning of a frame of the output image data, the length of the k-th interval is equal to two frames of the output image data, and x=2p/q (where the ratio of the frame frequency of the input image data and the frame frequency of the output image data is equal to p:q).

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel of an LCD according to an embodiment of the present invention;

FIG. 3 is a graph illustrating a front gamma curve and a lateral gamma curve before modification and a front gamma curve and a lateral gamma curve after modification according to an embodiment of the present invention;

FIG. 4 illustrates a pixel arrangement according to an embodiment of the present invention;

FIG. 5 illustrates waveforms of data signals applied to the pixels according to an embodiment of the present invention;

FIG. 6 shows a rule for converting the input image data with a frame frequency of 60 Hz into the lower and higher output image data with a frequency of 80 Hz according to an embodiment of the present invention;

FIG. 7 shows a rule for converting the input image data with a frame frequency of 60 Hz into the lower and higher output image data with a frequency of 90 Hz according to an embodiment of the present invention;

FIG. 8 shows a rule for calculating the time-averaged transmittance during two frames of the lower and higher output image data when the output frame frequency is not twice the input frame frequency;

FIG. 9 is a flow chart illustrating the data conversion shown in FIG. 6 where the output frame frequency is 4/3 times the input frame frequency;

FIG. 10 is a flow chart illustrating the data conversion shown in FIG. 7 where the output frame frequency is 3/2 times the input frame frequency; and

FIGS. 11-13 illustrate waveforms of data signals according to embodiments of the present invention.

### DETAILED DESCRIPTION OF EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Like numerals refer to like elements throughout.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, liquid crystal displays as an example of display device according to embodiments of the present invention will be described with reference to the accompanying drawings.

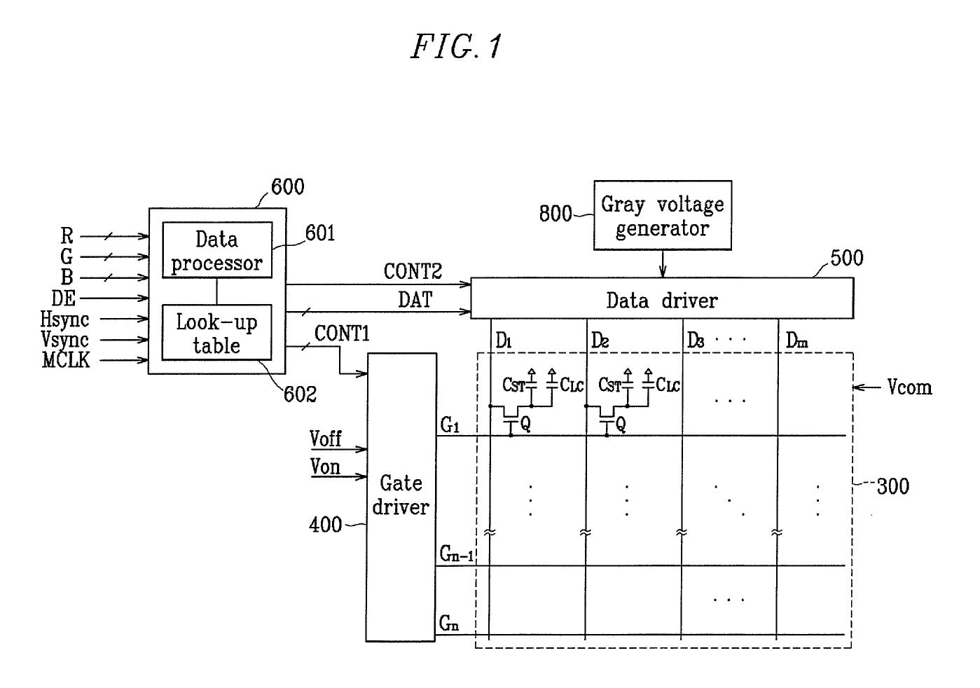

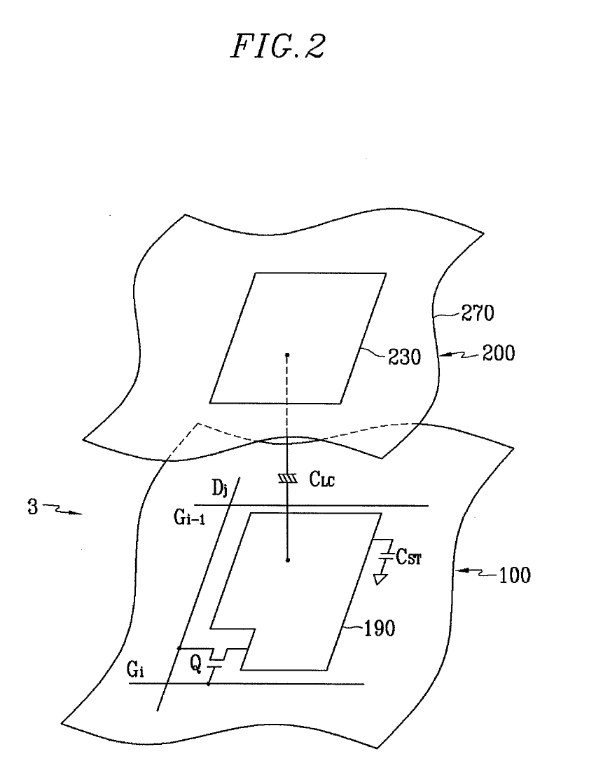

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator 800 connected to the data driver 500, and a signal controller 600 controlling the above elements.

Referring to FIG. 1, the panel assembly 300 includes a plurality of display signal lines G₁-Gₙ and D₁-Dₘ and a plurality of pixels connected thereto and arranged substantially in a matrix. In a structural view shown in FIG. 2, the panel assembly 300 includes lower and upper panels 100 and 200 and a LC layer 3 interposed therebetween.

The display signal lines G₁-Gₙ and D₁-Dₘ are disposed on the lower panel 100 and include a plurality of gate lines G₁-Gₙ transmitting gate signals (also referred to as “scanning signals”), and a plurality of data lines D₁-Dₘ transmitting data signals. The gate lines G₁-Gₙ extend substantially in a row direction and substantially parallel to each other, while the data lines D₁-Dₘ extend substantially in a column direction and substantially parallel to each other.

Each pixel includes a switching element Q connected to the signal lines G₁-Gₙ and D₁-Dₘ, and a LC capacitor C_{LC} and a storage capacitor C_{ST} that are connected to the switching element Q. In other embodiments, the storage capacitor C_{ST} may be omitted.

The switching element Q including a TFT is provided on the lower panel 100 and has three terminals: a control terminal connected to one of the gate lines G₁-Gₙ; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q, and the common electrode 270 is supplied with a common voltage Vcom and covers an entire surface of the upper panel 200. In other embodiments, the common electrode 270 may be provided on the lower panel 100, and at least one of the electrodes 190 and 270 may have a shape of bar or stripe.

The storage capacitor C_{ST} is an auxiliary capacitor for the LC capacitor C_{LC}. The storage capacitor C_{ST} includes the pixel electrode 190 and a separate signal line, which is provided on the lower panel 100, overlapping the pixel electrode 190 via an insulator, which is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of primary colors (i.e., spatial division) or each pixel sequentially represents the primary colors in turn (i.e., temporal division) such that spatial or temporal sum of the primary colors are recognized as a desired color. FIG. 2 shows an example of the spatial division that each pixel includes a color filter 230 representing one of the primary colors in an area of the upper panel 200 facing the pixel electrode 190. Alternatively, the color filter 230 is provided on or under the pixel electrode 190 on the lower panel 100.

An example of a set of the primary colors includes red, green, and blue colors. The pixels including red, green, and blue color filters are referred to as red, green, and blue pixels, respectively.

One or more polarizers (not shown) are attached to at least one of the panels 100 and 200. In addition, one or more retardation films (not shown) for compensating refractive anisotropy may be disposed between the polarizer(s) and the panel(s).

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternately, the drivers 400 and 500 may be integrated into the panel assembly 300 along with the display signal lines G₁-Gₙ and D₁-Dₘ and the TFT switching elements Q.

The signal controller 600 controls the gate driver 400 and the gate driver 500 and includes a data processor 601 and a look-up table 602 for conversion of image data.

Now, the operation of the above-described LCD will be described in detail.

The signal controller 600 is supplied with input image signals R, G and B and input control signals controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and processing the image signals R, G and B suitable for the operation of the panel assembly 300 on the basis of the input control signals and the input image signals R, G and B, the signal controller 600 transmits the gate control signals CONT1 to the gate driver 400, and the processed image signals DAT and the data control signals CONT2 to the data driver 500. The processing of the image signals R, G and B includes the conversion of the input image data R, G and B by the data processor 601 and the look-up table 602. The data processor 601 selects output grays stored in the look-up table 602 based on the gray of the input image data R, G and B and assigns the output grays to the pixels in spatial division or in temporal division, which will be described later.

The gate control signals CONT1 include a scanning start signal STV for instructing the gate driver 400 to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing the data driver 500 of start of data transmission for a group of pixels, a load signal LOAD for instructing to apply the data voltages to the data lines D₁-Dₘ, and a data clock signal HCLK. The data control signal CONT2 may further include an inversion signal RVS for reversing the polarity of the data voltages (with respect to the common voltage Vcom).

Responsive to the data control signals CONT2 from the signal controller 600, the data driver 500 receives a packet of the image data DAT for the group of pixels from the signal controller 600, converts the image data DAT into analog data voltages selected from the gray voltages supplied from the gray voltage generator 800, and applies the data voltages to the data lines D₁-Dₘ.

The gate driver 400 applies the gate-on voltage Von to the gate line G₁-Gₙ in response to the gate control signals CONT1 from the signal controller 600, thereby turning on the switching elements Q connected thereto. The data voltages applied to the data lines D₁-Dₘ are supplied to the pixels through the activated switching elements Q.

The difference between the data voltage and the common voltage Vcom is represented as a voltage across the LC capacitor C_{LC}, which is referred to as a pixel voltage. The LC molecules in the LC capacitor C_{LC} have orientations depending on the magnitude of the pixel voltage, and the molecular orientations determine the polarization of light passing through the LC layer 3. The polarizer(s) converts the light polarization into the light transmittance.

By repeating this procedure by a unit of half of a horizontal period (which is denoted by “½H” and equal to half period of the horizontal synchronization signal Hsync or the data enable signal DE), all gate lines G₁-Gₙ are sequentially supplied with the gate-on voltage Von during a frame, thereby applying the data voltages to all pixels. When the next frame starts after one frame finishes, the inversion control signal RVS applied to the data driver 500 is controlled such that the polarity of the data voltages is reversed (which is referred to as “frame inversion”). The inversion control signal RVS may be also controlled such that the polarity of the data voltages flowing in a data line in one frame are reversed (for example, line inversion and dot inversion), or the polarity of the data voltages in one packet are reversed (for example, column inversion and dot inversion).

Now, the data conversion of the data processor of the signal controller according to embodiments of the present invention will be described in detail.

1. Gray Conversion Rule

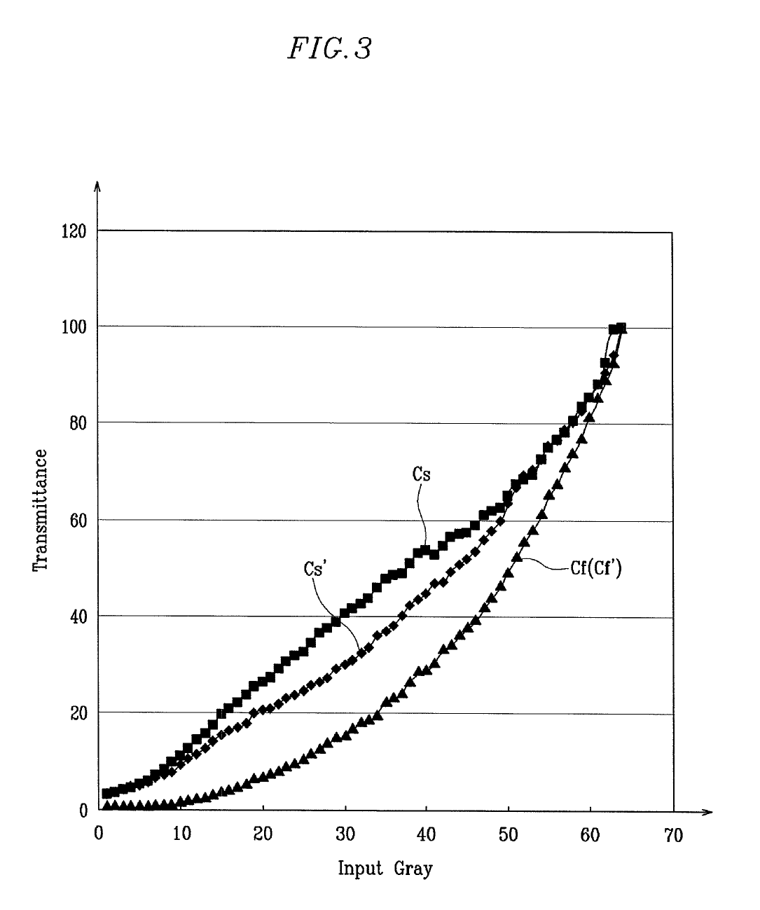

First, a gray conversion rule stored in the look-up table 602 will be described in detail with reference to FIG. 3.

FIG. 3 is a graph illustrating a front gamma curve and a lateral gamma curve before modification and a front gamma curve and a lateral gamma curve after modification according to an embodiment of the present invention.

Referring to FIG. 3, a gamma curve Cf in a front view (referred to as “front gamma curve” hereinafter) and a gamma curve Cs in a side view (referred to as “lateral gamma curve” hereinafter) are obtained after the transmittance in a front view (referred to as “front transmittance” hereinafter) and the transmittance in a side view (referred to as “lateral transmittance” hereinafter) are measured for each gray. For each gray (referred to as “original gray” hereinafter), among pairs of lower and higher grays relative to the original gray, several pairs of lower and higher grays are selected, which satisfy a condition that an average of the front transmittance of the lower gray and the front transmittance of the higher gray (referred to as “average front transmittance” hereinafter) is equal to the front transmittance of the original gray and thus an average front gamma curve Cf′, i.e., the average front transmittance as function as the original gray is the same as the original front gamma curve Cf.

For each of the selected pairs of lower and higher grays, an average of the lateral transmittance of the lower gray and the lateral transmittance of the higher gray (referred to as “average lateral transmittance” hereinafter) is calculated. A pair of lower and higher grays for each of the original grays is finally selected such that an average lateral gamma curve Cs′, i.e., the average lateral transmittance as function of the original gray has a shape closest to the average front gamma curve Cf′ or the original front gamma curve Cf. In other words, among several pairs of lower and higher grays that have an average front transmittance equal to the front transmittance of the original gray, a pair of lower and higher grays that gives the average lateral gamma curve Cs′ the least distorted from the front gamma curve is selected.

In this way, a pair of lower and higher grays that gives the average lateral gamma curve Cs′ the most similar to the front gamma curve Cf or Cf′ are obtained for each of the original grays. The obtained lower and higher grays are stored as lower and higher output grays as function of the original gray into the look-up table 602.

TABLE 1 illustrates an example of lower and higher output grays as function of the original gray. The total number of the original grays shown in TABLE 1 is 64.

TABLE 1

| GRAY | LOW | HIGH |
|---|---|---|
| 0 | 0 | 0 |
| 1 | 0 | 2 |
| 2 | 0 | 4 |
| 3 | 0 | 5 |
| 4 | 0 | 6 |
| 5 | 0 | 7 |
| 6 | 0 | 8 |
| 7 | 0 | 9 |
| 8 | 0 | 10 |
| 9 | 0 | 12 |
| 10 | 0 | 13 |
| 11 | 0 | 14 |
| 12 | 0 | 16 |
| 13 | 0 | 18 |
| 14 | 0 | 20 |
| 15 | 0 | 21 |
| 16 | 0 | 22 |
| 17 | 0 | 24 |
| 18 | 0 | 26 |
| 19 | 0 | 27 |
| 20 | 0 | 28 |
| 21 | 0 | 29 |
| 22 | 0 | 31 |
| 23 | 0 | 32 |
| 24 | 0 | 33 |
| 25 | 0 | 34 |
| 26 | 0 | 36 |
| 27 | 0 | 37 |
| 28 | 3 | 38 |
| 29 | 5 | 39 |
| 30 | 6 | 41 |
| 31 | 7 | 42 |
| 32 | 8 | 43 |
| 33 | 11 | 44 |
| 34 | 10 | 46 |
| 35 | 11 | 47 |
| 36 | 13 | 48 |
| 37 | 14 | 49 |
| 38 | 14 | 50 |
| 39 | 16 | 50 |
| 40 | 18 | 51 |
| 41 | 16 | 53 |
| 42 | 19 | 53 |
| 43 | 19 | 54 |
| 44 | 20 | 55 |
| 45 | 21 | 56 |
| 46 | 23 | 57 |
| 47 | 23 | 58 |
| 48 | 25 | 59 |
| 49 | 30 | 59 |
| 50 | 35 | 59 |
| 51 | 38 | 59 |
| 52 | 40 | 60 |
| 53 | 44 | 60 |
| 54 | 48 | 60 |
| 55 | 49 | 60 |
| 56 | 52 | 60 |
| 57 | 53 | 60 |
| 58 | 53 | 61 |
| 59 | 56 | 61 |
| 60 | 58 | 61 |
| 61 | 60 | 61 |
| 62 | 60 | 63 |
| 63 | 63 | 63 |

An original gray may be converted into three or more output grays, which have average front transmittance equal to original front transmittance and generate an average lateral gamma curve similar to an original front gamma curve. At this time, all the output grays may have different values or two or more output grays may have an equal value.

2. Assignment of Output Image Data

Next, a rule for assigning the output grays to pixels after selecting a plurality of output grays from the look-up table 602 for input image data R, G and B is described in detail.

2.1 Spatial Division

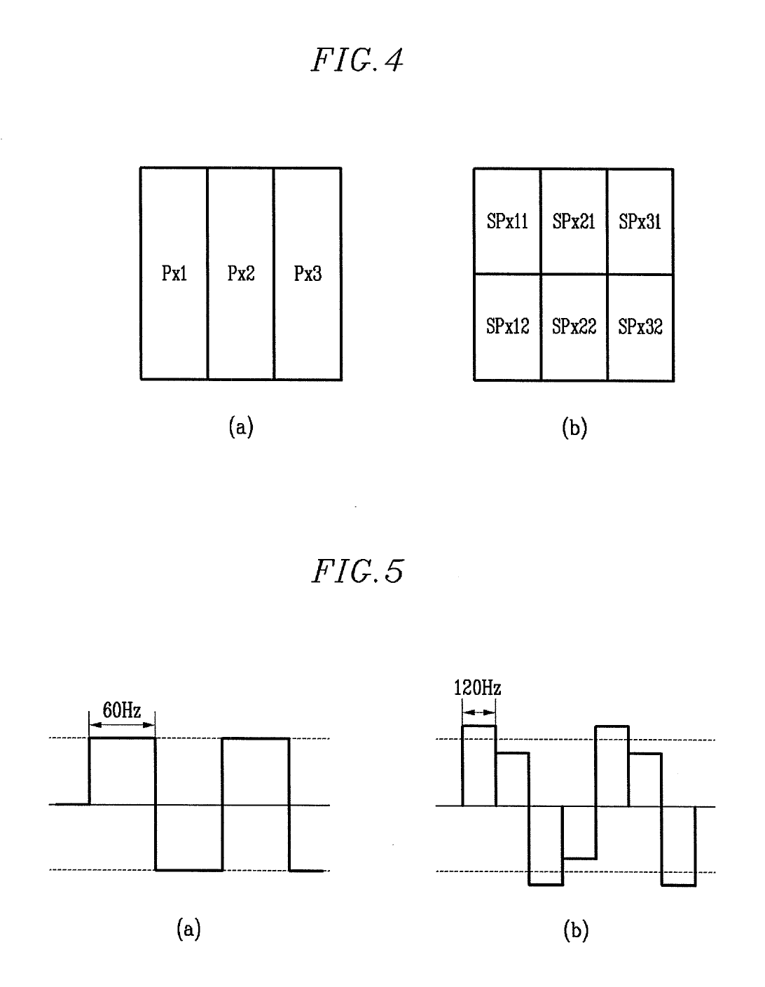

Referring to FIG. 4, a spatial division is described in detail.

FIG. 4 illustrates arrangements of pixels. A general pixel arrangement is denoted by (a) and a pixel arrangement according to an embodiment of the present invention is denoted by (b). Each pixel shown in (b) of FIG. 4 includes two subpixels.

The spatial division is that each pixel is divided into two subpixels, an input image data for the pixel is converted into a lower output image data having a lower output gray and a higher output image data having a higher output gray, and the lower and higher output image data are assigned to the two subpixels.

For example, as shown in (a) and (b) of FIG. 4, a pixel Px1, Px2 or Px3 is divided into two subpixels SPx11 and SPx12, SPx21 and SPx22, or SPx31 and SPx32, which are arranged in a column direction. In this case, a gate line is required on the panel assembly 300 for each subpixel SPx11, SPx12, SPx21, SPx22, SPx31, or SPx32 and thus the number of gate lines becomes double and the horizontal frequency (reverse to the horizontal period) also becomes double.

Alternatively, a pixel may be divided into two subpixels arranged in a row direction. In this case, the number of data lines becomes double and the frequency of a data clock signal HCLK supplied from the signal controller 600 to the data driver 500 becomes double.

When a gray is converted into three or more output grays, a pixel may be divided into three or more subpixels arranged in the row or column direction. In this case, the horizontal frequency or the frequency of the data clock signal HCLK is increased depending on the number of the subpixels.

2.2 Temporal Division

The temporal division is that the frame frequency of the output image data (referred to as “output frame frequency” hereinafter) is differentiated from the frame frequency of the input image data (referred to as “input frame frequency” hereinafter), a plurality of output image data for each pixel are obtained depending on the ratio of the input frame frequency and the output frame frequency, and the output image data are assigned to different frames.

Some examples will be described.

2.2.1 Output Frame Frequency is Twice Input Frame Frequency

An example of the temporal division is to increase the output frame frequency twice the input frame frequency, which will be described with reference to FIG. 5.

FIG. 5 illustrates waveforms of data signals applied to the pixels. (a) shows a data signal having a frame frequency of 60 Hz before conversion and (b) shows a data signal having a frame frequency of 120 Hz after conversion.

Referring to FIG. 5, higher and lower output grays for an input gray for each pixel are obtained and the higher and lower output image data corresponding thereto are assigned to respective frames when the input frame frequency is about 60 Hz and the output frame frequency is twice the input frame frequency, i.e., 120 Hz.

For an example shown in (b) of FIG. 5, the higher output image data is assigned to the first frame and the lower output image data is assigned to the second frame. It is apparent that the lower output image data may be assigned to the first frame and the higher output image data is assigned to the second frame. Other sequences for assigning the lower and higher output data can be possible.

When the output frame frequency is twice the input frame frequency as described above, the higher and lower output grays corresponding to the input gray of the input image data are obtained from the look-up table 602 and the output image data having the higher and lower output grays are assigned to the frames without particular processing.

Just as when the output frame frequency is twice the input frame frequency, when the output frame frequency is even times the input frame frequency the lower and higher output image data are assigned in the same manner. In this case, the lower output image data and the higher output image data are repeatedly assigned to multiple frames.

2.2.2 Output Frame Frequency is not Twice Input Frame Frequency

When the output frame frequency is not twice the input frame frequency, the transmittance of the input image data is time-averaged based on the ratio of the output frame frequency and the input frame frequency, a plurality of output grays are obtained from the look-up table 602 based on a gray corresponding to the time-averaged transmittance, and the output grays are assigned to the frames.

Since the temporal division assigns the higher and lower output image data to respective frames, the transmittance of the input image data is time-averaged for two frames of the higher and lower output image data. Thereafter, a gray corresponding to the time-averaged transmittance is found and the higher and lower output grays corresponding to the found gray are obtained from the look-up table 602.

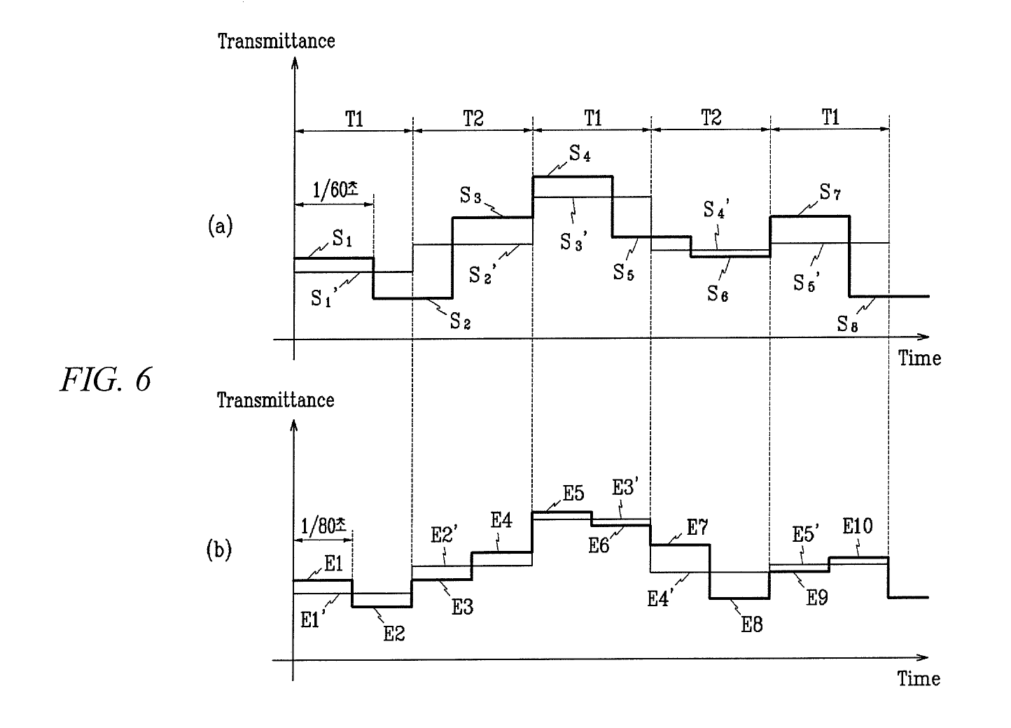

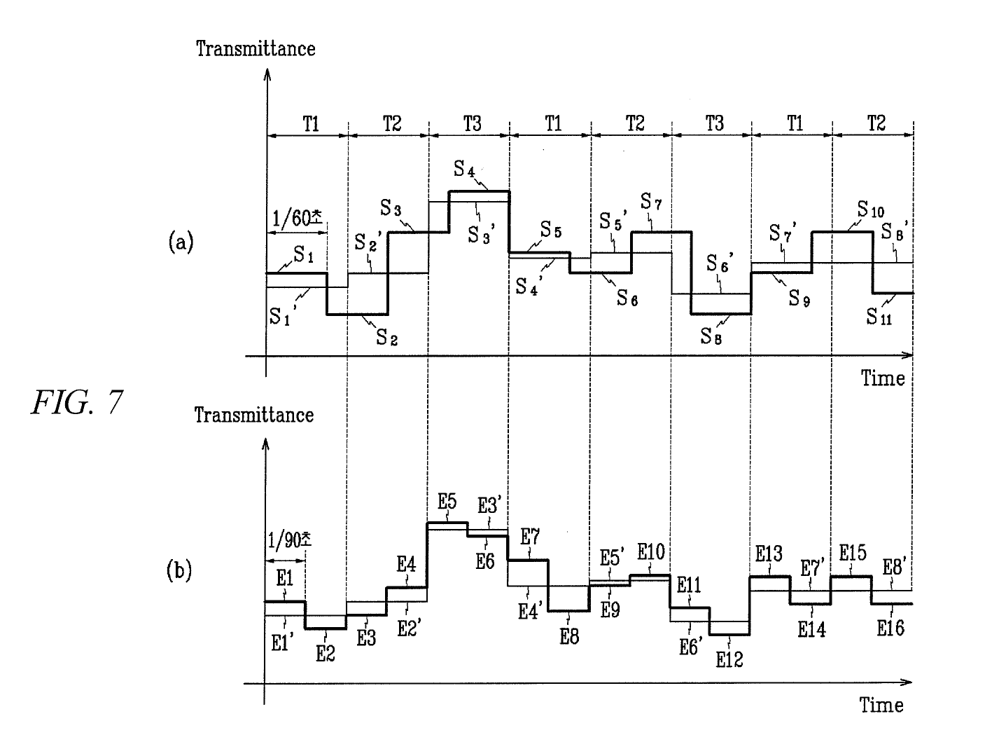

An example that the frame frequency is increased 4/3 times from 60 Hz to 80 Hz and another example that the frame frequency is increased 3/2 times from 60 Hz to 90 Hz are described in detail with reference to FIGS. 6 and 7.

FIG. 6 shows a rule for converting the input image data with a frame frequency of 60 Hz into the lower and higher output image data with a frequency of 80 Hz according to an embodiment of the present invention. FIG. 6(a) illustrates the transmittance of the input image data and FIG. 6(b) illustrates the transmittance of the output image data.

FIG. 7 shows a rule for converting the input image data with a frame frequency of 60 Hz into the lower and higher output image data with a frequency of 90 Hz. FIG. 7(a) illustrates the transmittance of the input image data and FIG. 7(b) illustrates the transmittance of the output image data according to an embodiment of the present invention.

Referring to FIGS. 6 and 7, the total period is divided by two frames of the lower and higher output image data.

Referring to FIG. 6, the ratio of the frame frequency of the input image data and the frame frequency of the output image data is 3:4, and thus the beginning of the (3k+1)th frame (k=0, 1, . . . ) for the input image data coincides with the beginning of the (4k+1)th frame for the output image data. Therefore, the time intervals are classified into two types, an interval T1 starting simultaneously with a frame of the input image data (referred to as “input frame” hereinafter) and an interval T2 starting from the middle of an input frame.

The transmittance is equal to S₃ₖ₊₁ during two thirds of the interval T1 and equal to S₃ₖ₊₂ during the remaining one third of the interval T1. Therefore, the time-averaged transmittance S₂ₖ₊₁′ of the input image data in the interval T1 is given by:

$$\begin{matrix}{S}_{2 k + 1}^{′} = \frac{2}{3} {S}_{3 k + 1} + \frac{1}{3} {S}_{3 k + 2} \\ = \frac{2}{3} ( {S}_{3 k + 1} + \frac{1}{2} {S}_{3 k + 2} ) \\ = \frac{1}{2} \times \frac{4}{3} \times ( {S}_{3 k + 1} + \frac{1}{2} {S}_{3 k + 2} ) .\end{matrix} \qquad Relation 1$$

Similarly, the time-averaged transmittance S₂ₖ₊₂′ of the input image data in the interval T2 is given by:

$$\begin{matrix}{S}_{2 k + 2}^{′} = \frac{1}{3} {S}_{3 k + 2} + \frac{2}{3} {S}_{3 k + 3} \\ = \frac{2}{3} ( \frac{1}{2} {S}_{3 k + 2} + {S}_{3 k + 3} ) \\ = \frac{1}{2} \times \frac{4}{3} \times ( \frac{1}{2} {S}_{3 k + 2} + {S}_{3 k + 3} ) .\end{matrix} \qquad Relation 2$$

Referring to FIG. 7, the ratio of the frame frequency of the input image data and the frame frequency of the output image data is 2:3, and thus the beginning of the (4k+1)th frame (k=0, 1, . . . ) for the input image data coincides with the beginning of the (6k+1)th frame for the output image data. Therefore, the time intervals are classified into three types, an interval T1 starting simultaneously with an input frame, an interval T2 starting from one thirds point of an input frame, and an interval starting from two thirds point of an input frame.

The transmittance is equal to S₄ₖ₊₁ during three fourths of the interval T1 and equal to S₄ₖ₊₂ during the remaining one fourths of the interval T1. Therefore, the time-averaged transmittance S₃ₖ₊₁′ of the input image data in the interval T1 is given by:

$$\begin{matrix}{S}_{3 k + 1}^{′} = \frac{3}{4} {S}_{4 k + 1} + \frac{1}{4} {S}_{4 k + 2} \\ = \frac{3}{4} ( {S}_{4 k + 1} + \frac{1}{3} {S}_{4 k + 2} ) \\ = \frac{1}{2} \times \frac{3}{2} \times ( {S}_{4 k + 1} + \frac{1}{3} {S}_{4 k + 2} ) .\end{matrix} \qquad Relation 3$$

Similarly, the transmittance is equal to S₄ₖ₊₂ during half of the interval T2 and equal to S₄ₖ₊₃ during the remaining half of the interval T2. Accordingly, the time-averaged transmittance S₃ₖ₊₂′ of the input image data in the interval T2 is given by:

$$\begin{matrix}{S}_{3 k + 2}^{′} = \frac{1}{2} {S}_{4 k + 2} + \frac{1}{2} {S}_{4 k + 3} \\ = \frac{1}{2} ( {S}_{4 k + 2} + {S}_{4 k + 3} ) \\ = \frac{1}{2} \times \frac{3}{2} \times ( \frac{2}{3} {S}_{4 k + 2} + \frac{2}{3} {S}_{4 k + 3} ) .\end{matrix} \qquad Relation 4$$

Finally, the transmittance is equal to S₄ₖ₊₃ during one fourths of the interval T3 and equal to S₄ₖ₊₄ during the remaining three fourths of the interval T3. Accordingly, the time-averaged transmittance S₃ₖ₊₃′ of the input image data in the interval T3 is given by:

$$\begin{matrix}{S}_{3 k + 3}^{′} = \frac{1}{4} {S}_{4 k + 3} + \frac{3}{4} {S}_{4 k + 4} \\ = \frac{3}{4} ( \frac{1}{3} {S}_{4 k + 3} + {S}_{4 k + 4} ) \\ = \frac{1}{2} \times \frac{3}{2} \times ( \frac{1}{3} {S}_{4 k + 3} + {S}_{4 k + 4} ) .\end{matrix} \qquad Relation 5$$

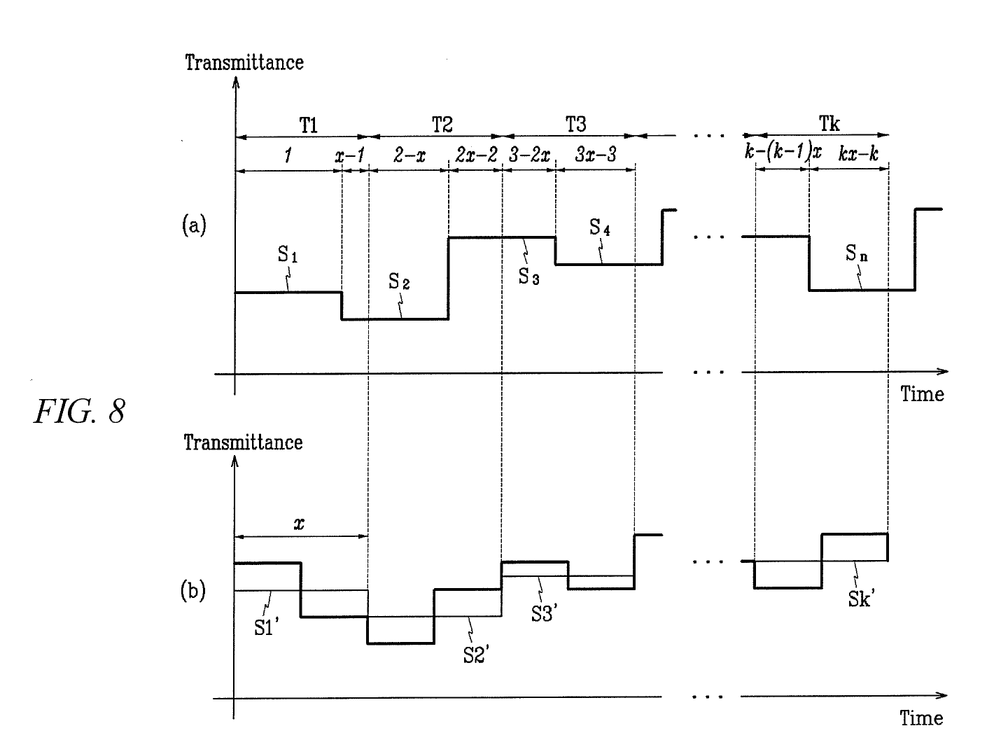

Referring to FIG. 8, the above-describe relations are generalized.

FIG. 8 shows a rule for calculating the time-averaged transmittance during two frames of the lower and higher output image data when the output frame frequency is not twice the input frame frequency. FIG. 8(a) illustrates the transmittance of the input image data and FIG. 8(b) illustrates the time-averaged transmittance in each interval and the lower and higher output grays corresponding thereto.

It is assumed that the ratio of the input frame frequency and the output frame frequency is equal to p:q, where p<q<2p. That is, the output frame frequency is higher than the input frame frequency, but smaller than twice the input frame frequency.

The number x of input frames corresponding to two output frames is obtained from p:q=x:2 as follows:

x=2p/q. Relation 6

Since p<q<2p, 1<x<2, that is, the number of input frames corresponding to two output frames ranges one to two. The number x can be considered as the length of each interval.

Considering the first interval T1, the transmittance is equal to S₁ during one of the total length x and equal to S₂ during the remaining (x−1) of the total length x. Therefore, the time-averaged transmittance S₁′ in the first interval T1 is given by:

$${S}_{1}^{′} = \frac{1}{x} \times [ {S}_{1} + ( x - 1 ) {S}_{2} ] . \qquad Relation 7$$

Considering the second interval T2, the transmittance is equal to S₂ during [1−(x−1)]=2−x of the total length x and equal to S₃ during the remaining x−(2−x) of the total length x. Therefore, the time-averaged transmittance S₂′ in the second interval T2 is given by:

$${S}_{2}^{′} = \frac{1}{x} \times [ ( 2 - x ) {S}_{2} + ( 2 x - 2 ) {S}_{3} ] . \qquad Relation 8$$

Considering the third interval T3, the transmittance is equal to S₃ during [1−(2x−2)]=3−2x of the total length x and equal to S₄ during the remaining x−(3−2x) of the total length x. Therefore, the time-averaged transmittance S₃′ in the third interval T3 is given by:

$${S}_{3}^{′} = \frac{1}{x} \times [ ( 3 - 2 x ) {S}_{3} + ( 3 x - 3 ) {S}_{4} ] . \qquad Relation 9$$

In this way, the time-averaged transmittance Sₖ′ in the k-th interval Tk is obtained as follows:

$${S}_{k}^{′} = \frac{1}{x} \times \{ [ k - ( k - 1 ) x ] {S}_{k} + ( kx - k ) {S}_{k + 1} \} . \qquad Relation 10$$

Here, the k-th interval Tk means the k-th interval among the intervals from a point where the beginning of the input frame coincides with the beginning of the output frame to a next point where the beginning of the input frame coincides with the beginning of the output frame as described about the definition of the intervals.

A gray corresponding to the time-averaged transmittance obtained in this way is then found and higher and lower output grays corresponding to the found gray are obtained from the look-up table 602. In FIGS. 6-8, E1, E2, . . . denote the transmittance of the output grays and E1′, E2′, . . . , denote the average transmittance of the higher and lower output grays.

In the meantime, the length of each interval may be equal to three or more frames of the output image data, particularly in a case that a gray is converted into three or more output grays.

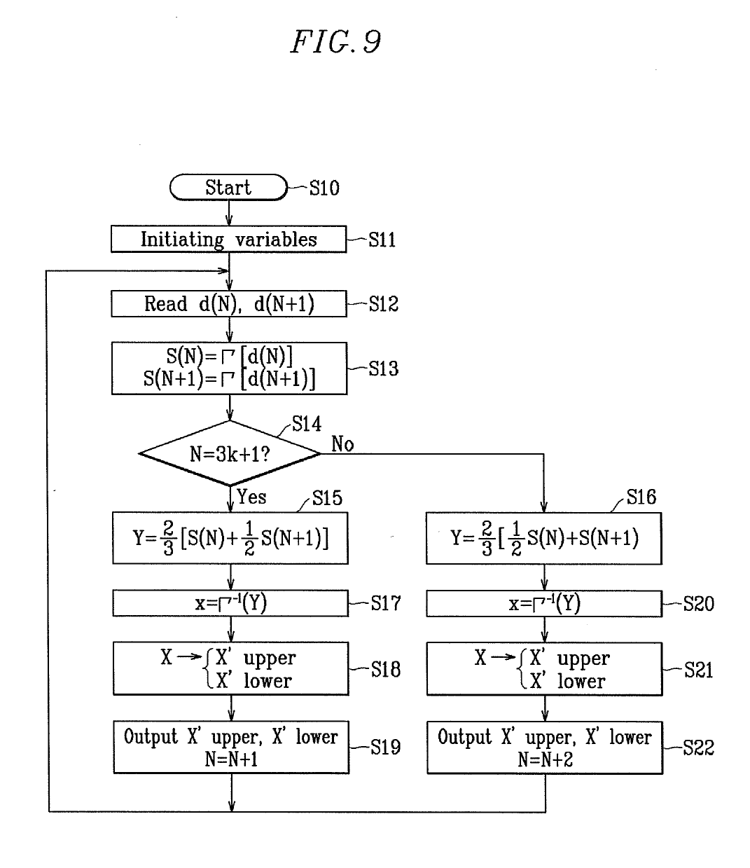

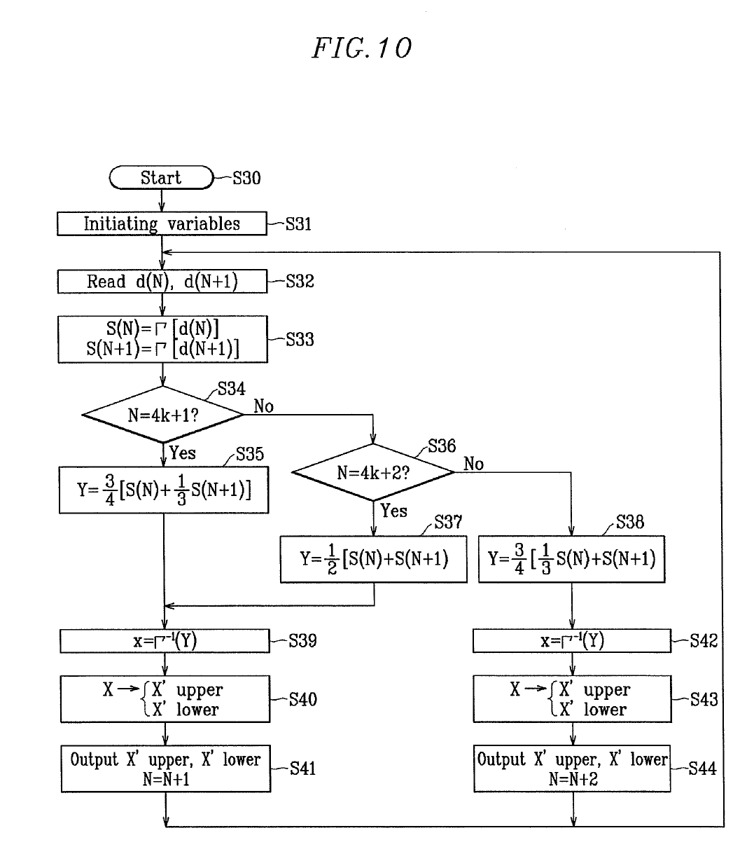

The operation of the data processor 601 in the signal controller 600 for converting input image data into lower and higher output image data and outputting them is described in detail with reference to FIGS. 9 and 10.

FIG. 9 is a flow chart illustrating the data conversion shown in FIG. 6 where the output frame frequency is 4/3 times the input frame frequency, and FIG. 10 is a flow chart illustrating the data conversion shown in FIG. 7 where the output frame frequency is 3/2 times the input frame frequency.

First, the data conversion of the data processor 601 when the output frame frequency of 80 Hz is 4/3 times the input frame frequency of 60 Hz is described with reference to FIGS. 6 and 9.

When the operation of the data processor 601 in the signal controller 600 starts (S10), the variables are initialized (S11). The data processor 601 reads out image data d(N) and d(N+1) for adjacent two frames stored in a frame memory (not shown) or entering from an external device (S12). Here, N indicates the serial number of a frame of the input image data.

The data processor 601 gamma converts the read-out input image data d(N) and d(N+1) to find the transmittances S(N) and S(N+1) corresponding thereto (S13).

The data processor 601 determines which interval shown in FIG. 6 the serial number N of the former frame of the input image data d(N) belongs to, that is, whether the frame number N of the input image data d(N) is equal to (3k+1) (S14).

When the frame number N of the input image data d(N) is equal to (3k+1), the data processor 601 calculates a time-averaged transmittance Y using Relation 1 (S15).

When the frame number N of the input image data d(N) is not equal to (3k+1), the data processor 601 calculates a time-averaged transmittance Y given by Relation 2 (S16).

The data processor 601 performs inverse-gamma conversion of the time-averaged transmittance Y to find a gray X corresponding thereto (S17 and S20), and finds a higher output gray X′upper and a lower output gray X′lower corresponding to the gray X from the look-up table 602 (S18 and S21).

The data processor 601 outputs image data having the higher output gray X′upper and the lower output gray X′lower to the data driver 500 as a higher output image data and a lower output image data. The data processor 601 increases the number N by one or two (S19 and S22) and performs the data conversion for the next interval.

At this time, the number N is increased by one when the frame number N of the input image data d(N) is equal to (3k+1) and the number N is increased by two when the frame number N of the input image data d(N) is equal to (3k+2).

Next, the data conversion of the data processor 601 when the output frame frequency of 90 Hz is 3/2 times the input frame frequency of 60 Hz is described with reference to FIGS. 7 and 10.

After the data processor 601 begins operation (S10), the data processor 601 performs the operations in the steps S31 to S33, which is substantially the same as those in the steps S11 to S13 shown in FIG. 9 and thus detailed description thereof will be omitted.

After obtaining the transmittances S(N) and S(N+1) corresponding to the input image data d(N) and d(N+1), the data processor 601 determines which interval shown in FIG. 7 the serial number N of the former frame of the input image data d(N) belongs to. In detail, the data processor 601 firstly determines whether the frame number N of the input image data d(N) is equal to (4k+1) (S34).

When the frame number N of the input image data d(N) is equal to (4k+1), the data processor 601 calculates a time-averaged transmittance Y using Relation 3 (S35).

When the frame number N of the input image data d(N) is not equal to (4k+1), the data processor 601 determines whether the frame number N of the input image data d(N) is equal to (4k+2) (S36).

When the frame number N of the input image data d(N) is equal to (4k+2), the data processor 601 calculates a time-averaged transmittance Y using Relation 4 (S37). When the frame number N of the input image data d(N) is not equal to (4k+2), the data processor 601 calculates a time-averaged transmittance Y given by Relation 5 (S38).

Thereafter, the data processor 601 performs inverse-gamma conversion of the time-averaged transmittance Y to find a gray X corresponding thereto (S39 and S42), and finds a higher output gray X′upper and a lower output gray X′lower corresponding to the gray X from the look-up table 602 (S40 and S43).

Next, the data processor 601 outputs image data having the higher output gray X′upper and the lower output gray X′lower to the data driver 500 as a higher output image data and a lower output image data. The data processor 601 increases the number N by one or two (S41 and S44) and performs the data conversion for the next interval.

At this time, the number N is increased by one when the frame number N of the input image data d(N) is equal to (4k+1) or (4k+2) and the number N is increased by two when the frame number N of the input image data d(N) is equal to (4k+3).

3. Application Type of Lower and Higher Data Signals

A plurality of output image data determined in the spatial division or the temporal division are converted into analog data signals by the data driver 500. For example, the data driver 500 converts the output image data into data voltages selected from the gray voltages generated by the gray voltage generator 800 and applies the data voltages to the pixels through the data lines D₁-Dₘ. The polarity of the data signals is determined by the inversion control signal.

Now, examples of applying the data signals to the data lines will be described in detail with reference to FIGS. 11 and 13.

FIGS. 11-13 illustrate waveforms of data signals according to embodiments of the present invention. FIGS. 11(a)-13(a) illustrate the data signals applied to odd data lines and FIGS. 11(b)-13(b) illustrate the data signals applied to even data lines.

Referring to (a) in FIG. 11, each of the odd data lines is supplied with higher data signals corresponding to the higher output image data for two frames and supplied with lower data signals corresponding to the lower output image data for next two frames. The polarity of the data signals is inverted every frame.

On the contrary, referring to (b) in FIG. 11, each of the even data lines is supplied with the lower data signals for two frames and supplied with the higher data signals for next two frames. The polarity of the data signals is also inverted every frame.

This application type reduces afterimage since the polarity of the data signals is inverted every frame and the average voltage level of the data voltages periodically vanishes.

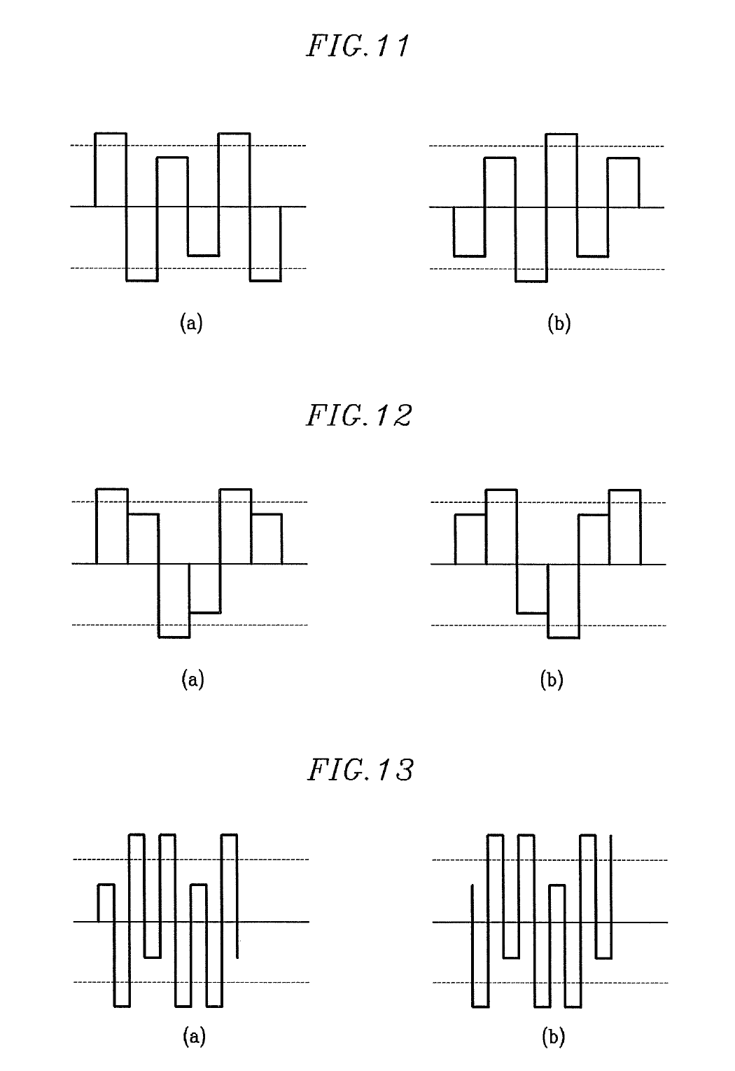

Referring to FIG. 12, higher and lower data signals are alternately applied for two frames and the polarity of the data signals is inverted every frame. The odd data line is supplied with a higher data signal when the even data line is supplied with a lower data signal, and vice versa.

In this case, since the data signals flowing along a data line are changed from the higher/lower data signal to the lower/higher data signal every frame, the deterioration of image quality due to the flickering is much reduced.

Referring to FIG. 13, the higher data signal is applied for two successive frames and the lower data is applied for a next frame. The polarity of the data signals is inverted every frame. This makes the average voltage level of the data signals vanish every frame to much reduce the deterioration of image quality due to the flickering.

As describe above, an input gray is converted into a pair of lower and higher output grays to be assigned to a pixel, which have the time-averaged transmittance giving a lateral gamma curve similar to a front gamma curve. Accordingly, the deterioration of image quality due to the difference in visibility between front and side views is decreased.

The present invention can be also employed to other display devices such as OLED.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. An apparatus of driving a display device including a plurality of pixels, the apparatus comprising:
a data processor that receives a plurality of sets of input image data having respective input grays and outputs a plurality of sets of output image data having respective output grays, each set of output image data corresponding to one of the plurality of sets of input image data; and
a data driver that supplies a corresponding pixel with data voltages corresponding to at least a portion of the output image data included in one of the plurality of sets of output image data supplied from the data processor sequentially during a predetermined time,
wherein a set of output grays corresponding to a set of input grays are selected from at least one set of grays, each set of grays giving an average front transmittance substantially equal to an average front transmittance of the set of input grays,
the sets of output grays generate the closest one of the average lateral gamma curves generated by the sets of grays relative to an average front gamma curve generated by the sets of input grays,
the average front transmittance is a time-averaged front transmittance over the predetermined time,
the data processor calculates a time-averaged transmittance by time-averaging the transmittance of the input image data based on a ratio of a frame frequency of the input image data and a frame frequency of the output image data, finds modified grays corresponding to the time-averaged transmittance, and obtains the output grays based on the modified grays, and
the frame frequency of the output image data is greater than the frame frequency of the input image data and smaller than twice the frame frequency of the input image data.

2. The apparatus of claim 1, wherein a set of output grays for an input gray comprise a higher output gray higher than the input gray and a lower output gray lower than the input gray and each set of output image data comprise a higher output image data having the higher output gray and a lower output image data having the lower output gray.

3. The apparatus of claim 2, further comprising a gray voltage generator generating a plurality of gray voltages, wherein the data voltages are selected from the gray voltages.

4. The apparatus of claim 2, wherein the data voltages comprise lower data voltages corresponding to the lower output image data and higher data voltages corresponding to the higher output image data.

5. The apparatus of claim 4, wherein either of the lower data voltages and the higher data voltages are successively applied for at least two frames and the polarity of the data voltages is inverted every frame.

6. The apparatus of claim 4, wherein the lower data voltages and the higher data voltages are alternately applied and the polarity of the data voltages is inverted every frame.

7. The apparatus of claim 1, further comprising a look-up table storing the corresponding values between the input grays and the output grays.

8. The apparatus of claim 1, wherein further comprising a look-up table storing the corresponding values between the modified grays and the output grays.

9. The apparatus of claim 1, wherein the time-averaged transmittance (Sₖ′) for a k-th interval (k=1, 2, . . . ) is given by:
$${S}_{k}^{′} = \frac{1}{x} \times \{ [ k - ( k - 1 ) x ] {S}_{k} + ( kx - k ) {S}_{k + 1} \} ,$$
where the k-th interval indicates the k-th interval among intervals from a point where beginning of a frame of the input image data coincides with beginning of a frame of the output image data to a next point where beginning of a frame of the input image data coincides with beginning of a frame of the output image data, the length of the k-th interval is equal to two frames of the output image data, and x=2p/q (where the ratio of the frame frequency of the input image data and the frame frequency of the output image data is equal to p:q).

10. A method of driving a display device including a look-up table, the method comprising:
receiving input image data having input grays;
calculating a modified gray by time-averaging the transmittance of the input grays based on a ratio of a frame frequency of the input image data and a frame frequency of the output image data;
reading out a plurality of output grays corresponding to the modified gray from the look-up table; and
outputting a plurality of output image data having the output grays,
wherein the frame frequency of the output image data is greater than the frame frequency of the input image data and smaller than twice the frame frequency of the input image data.

11. The method of claim 10, wherein the calculation of the modified gray comprises:
gamma converting the input grays to obtain the transmittance corresponding to the input grays;
time-averaging the transmittance to obtain a time-averaged transmittance; and
inverse-gamma converting the time-averaged transmittance to obtain the modified gray.

12. The method of claim 11, wherein the time-averaged transmittance (Sₖ′) for a k-th interval (k=1, 2, . . . ) is given by:
$${S}_{k}^{′} = \frac{1}{x} \times \{ [ k - ( k - 1 ) x ] {S}_{k} + ( kx - k ) {S}_{k + 1} \} ,$$
where the k-th interval indicates the k-th interval among intervals from a point where beginning of a frame of the input image data coincides with beginning of a frame of the output image data to a next point where beginning of a frame of the input image data coincides with beginning of a frame of the output image data, the length of the k-th interval is equal to two frames of the output image data, and x=2p/q (where the ratio of the frame frequency of the input image data and the frame frequency of the output image data is equal to p:q).

13. A display device comprising:
a plurality of pixels including switching elements;
a plurality of gate lines transmitting gate signals to the switching elements;
a plurality of data lines connected to the switching elements;
a signal controller that selects a plurality of output grays based on input grays of input image data and outputs a plurality of output image data having the output grays; and
a data driver that applies data voltages corresponding to at least a portion of the output image data included in the plurality of output image data supplied from the signal controller to the switching elements through the data lines sequentially during a predetermined time,
wherein the output grays corresponding to an input gray are selected from at least one set of grays giving an average front transmittance substantially equal to a front transmittance of the input gray and the output grays generate the closest one of the average lateral gamma curves generated by at least one set of grays relative to a front gamma curve generated by the input grays, and
wherein the average front transmittance is a time-averaged front transmittance over the predetermined time,
the data processor calculates a time-averaged transmittance by time-averaging the transmittance of the input image data based on a ratio of a frame frequency of the input image data and a frame frequency of the output image data, finds modified grays corresponding to the time-averaged transmittance, and obtains the output grays based on the modified grays, and
the frame frequency of the output image data is greater than the frame frequency of the input image data and smaller than twice the frame frequency of the input image data.

14. The display device of claim 13, wherein the signal controller calculates a time-averaged transmittance by time-averaging the transmittance of the input image data based on a ratio of a frame frequency of the input image data and a frame frequency of the output image data, finds modified grays corresponding to the time-averaged transmittance, and obtains the output grays based on the modified grays.

15. The display device of claim 14, wherein the signal controller comprises a look-up table storing the correspondence between the modified grays and the output grays.

16. The display device of claim 14, wherein the time-averaged transmittance (Sₖ′) for a k-th interval (k=1, 2, . . . ) is given by:
$${S}_{k}^{′} = \frac{1}{x} \times \{ [ k - ( k - 1 ) x ] {S}_{k} + ( kx - k ) {S}_{k + 1} \} ,$$
where the k-th interval indicates the k-th interval among intervals from a point where beginning of a frame of the input image data coincides with beginning of a frame of the output image data to a next point where beginning of a frame of the input image data coincides with beginning of a frame of the output image data, the length of the k-th interval is equal to two frames of the output image data, and x=2p/q (where the ratio of the frame frequency of the input image data and the frame frequency of the output image data is equal to p:q).

17. The apparatus of claim 1, wherein the predetermined time comprises at least two frames.

18. The display device of claim 13, wherein the predetermined time comprises at least two frames.
